(19) United States
(12) Patent Application Publication
(10) Pub. No.: US 2020/0376756 A1
(43) Pub. Date: Dec. 3, 2020

(54) Method for Producing Three-Dimensional Shaping Product by Joining Top Undercut Region and Bottom Interior Space-Forming Region

(71) Applicant: Matsuura Machinery Corporation, Fukui City (JP)

(72) Inventor: Satoru Tarumi, Fukui City (JP)

(21) Appl. No.: 16/711,831

(22) Filed: Dec. 12, 2019

(30) Foreign Application Priority Data
May 27, 2019 (JP) 2019-098721

(51) Int. Cl. B29C 64/188; B29C 64/153; B29C 64/386; B33Y 50/00

(52) U.S. Cl. CPC B29C 64/188; B29C 64/153; B33Y 10/00; B33Y 50/00; B29C 64/386

(57) ABSTRACT

A method for producing a three-dimensional shaped product having an undercut region on the upper side and an interior space forming region on the lower side, by lamination of powder, sintering of a laminated layer and cutting of the sintered layer, includes the steps of, when a cutting path where the side is a location of the top edge of the interior space that has been created during creation of horizontal cutting paths for cutting of the interior space forming region, setting by the CAD/CAM system a command for carrying out further lamination at the location of the top edge, or creating a horizontal cutting path on a location on an upper side above the horizontal cutting path by a cutting width and setting a command to the cutting tool for terminating cutting along the cutting path, thereby avoiding having to cut a created horizontal cutting path.

### TECHNICAL FIELD

The present invention relates to a method for producing a three-dimensional shaped product by joining a top undercut region and a bottom interior space-forming region, wherein, after lamination, sintering and cutting of the bottom interior space-forming region are carried out first, lamination and sintering of the top undercut region are carried out.

### BACKGROUND ART

Three-dimensional shaped products which is formed according to lamination with a powder while a squeegee is traveling, sintering with irradiation of a laser beam or an electron beam and cutting by a traveling cutting tool, include three-dimensional shaped products with a construction in which a top undercut region, i.e. the undercut region having the lower side formed by lamination and sintering, is joined with a pipe-shaped region forming the interior space on the lower side.

Control for three-dimensional shaping is usually accomplished by a CAD/CAM system, but for creation of a cutting path for a cutting tool by the CAD/CAM system, it is presupposed that the regions containing the cutting path are regions in which the cutting tool can be inserted.

For formation of an enclosed interior space of the three-dimensional shaped product, therefore, such as the inner side of a water conduit, it is considered to be impossible to automatically create the cutting path in the interior space by the CAD/CAM system unless the cutting tool can be inserted from the start.

In light of this problem, Patent Document 1 proposes using a laser light beam for interior cutting of the three-dimensional shaped product by the CAD/CAM system with adjustment of the focal point of the light beam, thereby avoiding using the cutting tool to create the cutting path in the interior space.

In contrast, in Patent Document 2, a horizontal cutting path is formed in the three-dimensional shaped product which forms the interior space, by the following steps set by the CAD/CAM system.

(1) An imaginary horizontal plane, i.e. a planned cutting plane, is defined at an intermediate location between the top edge and the bottom edge of the interior space.

(2) A horizontal cutting path is created in the lower region of the planned cutting plane.

(3) A horizontal cutting path is created in the upper region of the planned cutting plane.

(4) Upon reaching the stage of cutting the horizontal cutting path located at the top edge within the horizontal cutting path of (2) above, a command to terminate cutting on the planned cutting plane of (1) above is set, and both horizontal cutting paths are joined by a command to progress to cutting of the horizontal cutting path located on the bottom edge within the horizontal cutting path of (3) above.

However, it is essential to create a special program for joining of both horizontal cutting paths at the top edge and bottom edge, as in (4) above.

Furthermore, the undercut region is usually present on the upper side of the planned cutting plane, and when the inner surface of the undercut region is cut, the cutting tool necessarily switches from the cutting portion on the upper side to the undercut cutting portion, making it unavoidable for the cutting width to be a small cutting width.

In step (3) above, however, the same cutting width is set as in step (2) above, and no consideration is given to switching of the cutting tool to an undercut cutting tool.

When a process is employed like the present invention, wherein the top undercut region and the bottom interior space-forming region are separately produced and both regions are joined, there is no need to create a planned cutting plane as in Reference 2, because the top edge of the interior space region on the lower side is opened.

However, when cutting with the side being the location of the top edge of the interior wall section of the region forming the interior space is carried out as final stage cutting step, the CAD/CAM system progresses to a step of automatically cutting a plane at the opening at the top edge in the horizontal direction by a program provided by the system itself.

Needless to mention, such cutting of the opening edge is unnecessary and meaningless, and is also a major hindrance in terms of accomplishing efficient three-dimensional shaping.

### PRIOR ART DOCUMENTS

### Patent Documents

[Patent Document 1] U.S. patent No. 2002/0100750
[Patent Document 2] Japanese Patent No. 6251447

### SUMMARY OF INVENTION

### Technical Problem

It is an object of the present invention to provide a method for efficient shaping of a three-dimensional shaped product by joining of a top undercut region and a lower side interior space-forming region without cutting in the horizontal direction at an opening located at the top edge of the interior space.

### Solution to Problem

In order to solve the aforementioned problem, the present invention comprises following basic constructions (a) and (b).

(a) A method for producing a three-dimensional shaped product based on lamination with a powder while a squeegee is traveling, sintering of the laminated layer by irradiation with a laser beam or an electron beam, and cutting of the sintered layer with traveling a cutting tool, wherein a top undercut region and a bottom interior space-forming region are joined by following steps:

1. A CAD/CAM system sets the following steps.

(1) Creation of a shape of the top undercut region that has a bottom edge opening, and creation of a shape of the bottom interior space-forming region that has a top edge opening.

(2) Creation of a horizontal cutting path based on each prescribed location of a cutting blade of the cutting tool, on an interior wall section in the region on a lower side forming the interior space, at each location in order toward the upper side from a location of the bottom edge or a location of a position apparently near to the bottom edge of the interior wall section, with a cutting width of the cutting blade as an unit.

(3) When the location of the horizontal cutting path created in order in step (2) above has reached the location of a final stage, which is the location of the opening top edge or a location below the location of the top edge by a shorter distance than the cutting width, setting of a command for further lamination at the location of the top edge.

(4) A command for joining the bottom edge of the undercut region and the top edge of the interior space-forming region.

2. Lamination and sintering in the lower region based on step 1(1) above.
3. Cutting the interior wall section along the horizontal cutting paths created by steps 1(2) and 1(3) above.
4. Lamination and sintering in the undercut region based on steps 1(1) and 1(4) above.

(b) A method for producing a three-dimensional shaped product based on lamination with a powder while a squeegee is traveling, sintering of the laminated layer by irradiation with a laser beam or an electron beam, and cutting of the sintered layer with traveling a cutting tool, wherein a top undercut region and a bottom interior space-forming region are joined by following steps:

1. A CAD/CAM system sets the following steps.
(1) Creation of a shape of the top undercut region that has a bottom edge opening, and creation of a shape of the bottom interior space-forming region that has a top edge opening.
(2) Creation of a horizontal cutting path based on each prescribed location of a cutting blade of the cutting tool, on an interior wall section in the region on a lower side forming the interior space, at each location in order toward the upper side from a location of the bottom edge or a location of a position apparently near to the bottom edge of the interior wall section, with a cutting width of the cutting blade as an unit.
(3) When the location of the horizontal cutting path created in order by step (2) above has reached the location of the opening top edge or a location below the location of the top edge by a shorter distance than the cutting width, creating a horizontal cutting path as a final stage at an upper side by the cutting width for either above location, and setting of a command for terminating cutting operation at the horizontal cutting path of the final stage for the cutting tool.
(4) A command for joining the bottom edge of the undercut region and the top edge of the interior space-forming region.
2. Lamination and sintering in the lower region based on step 1(1) above.
3. Cutting the interior wall section along the horizontal cutting paths created by steps 1(2) and 1(3) above.
4. Lamination and sintering in the undercut region based on steps 1(1) and 1(4) above.

### Advantageous Effects of Invention

In the basic constructions (a) and (b), if the bottom interior space-forming region has an opening at the top edge, then the horizontal cutting path may be set as in step 1(2) without setting the planned cutting plane as in Patent Document 2.

Even if the planned cutting plane is not set, it is not necessary to create a special program in order to join the horizontal cutting path on the lower side and the horizontal cutting path on the upper side of the planned cutting plane, as in the construction of Patent Document 2.

However, as is explained under Background Art above, with current CAD/CAM systems, the horizontal cutting path is simply set and cutting is carried out based on the setting, and when the final stage is cutting at the opening where the side is the location of the top edge of the lower region, the CAD/CAM system is programmed to automatically effect control for cutting in the horizontal direction at the opening at the top edge at the stage where the final stage of cutting has been completed, and when cutting is carried out based on the programming, the cutting constitutes a hindrance against efficient shaping.

In the basic construction (a), when cutting has been carried out along the horizontal cutting path of the final stage at the uppermost side in step 1(3), the command for further lamination at the opening of the top edge is set as a subsequent step.

According to the command, the CAD/CAM system judges that further cutting has been carried out after the further lamination and sintering in the region on the upper side of the opening, and judges that the cutting at the opening is not the final stage cutting, thus it is avoided to cut in the horizontal direction at the opening.

In the basic construction (b), a horizontal cutting path on a location at upper side of the location of the top edge by the cutting width of the cutting tool or a horizontal cutting path on a location at upper side of the location of the top edge a shorter distance than the cutting width, i.e. a horizontal cutting path on a location at upper side of the horizontal cutting path by the cutting width at the final stage of the basic construction (a) is set as the cutting path of the final stage, then a command is set for the cutting tool to terminate the cutting operation in the cutting path at the final stage.

According to the terminating command, in the basic construction (b), it is possible to avoid automatic cutting in the horizontal direction at the final stage by the CAD/CAM system, since cutting is not carried out at the final stage.

Furthermore, with the horizontal cutting path located at the second higher point, i.e. the horizontal cutting path at the final stage of the basic construction (a), it is possible for cutting of the opening where the side is as the location of the top edge in the lower region to be the actual cutting step at the final stage.

Additionally, when cutting for an inner surface of the undercut region is carried out as in the embodiment described below, the cutting tool for the undercut region sets a cutting path suited for the cutting width, and the problem does not arise as in Patent Document 2 which ignores the difference between both cutting widths.

### BRIEF DESCRIPTION OF DRAWINGS

FIG. 1(a) is a flow chart showing each of the steps of the basic construction (a).

FIG. 1(b) is a vertical cross-sectional view of the basic construction (a).

It shows selection of a region apparently near the bottom edge of the interior wall section as the start location for the horizontal cutting path in step 1(2).

FIG. 2(a) is a flow chart showing each of the steps of the basic construction (b).

FIG. 2(b) is a vertical cross-sectional view of the basic construction (b).

It shows selection of the bottom edge of the interior wall section as the start location of the horizontal cutting path in step 1(2).

FIG. 3(a) is a flow chart showing each of the steps for an embodiment in which the inner surface of the undercut region is cut.

FIG. 3(b) is a vertical cross-sectional view for an embodiment in which the inner surface of an undercut region is cut.

FIG. 4 is a side view showing the state of the cutting tool being employed for an Example.

### DESCRIPTION OF EMBODIMENTS

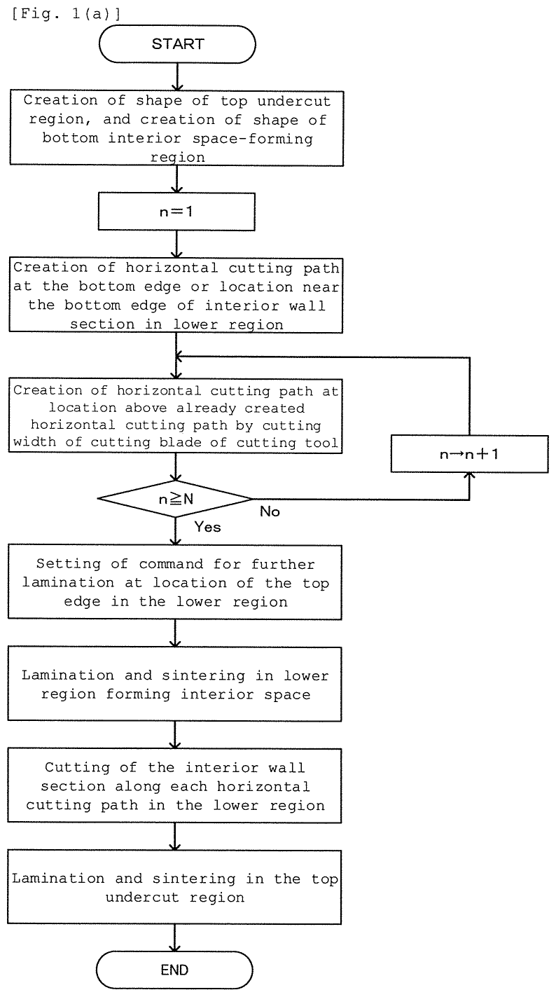

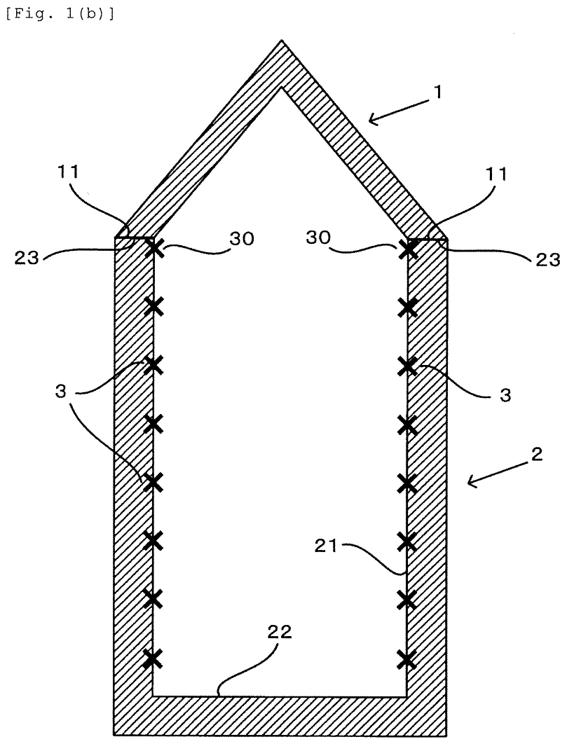

As shown by FIGS. 1(a) and (b), in the basic construction (a), shaping is carried out in a bottom interior space-forming region 2 and then the shaping is carried out in a top undercut region 1, by the following steps.

Note that N in FIG. 1(a) represents the number of horizontal cutting paths 3 necessary until the horizontal cutting path 3 reaches a horizontal cutting path 30 at the final stage, which is a location 23 of the top edge of the bottom interior space-forming region 2 or a location below the location 23 by a shorter distance than a cutting width, while FIG. 1(b) represents a case in which the horizontal cutting path 30 at the final stage corresponding to N of FIG. 1(a) is a location below the top edge 23 by a shorter distance than the cutting width.

1. A CAD/CAM system sets the following steps.

(1) Creation of a shape of the top undercut region 1 that has a bottom edge 11 opening, and creation of a shape of the bottom interior space-forming region 2 that has the top edge 23 opening.

(2) Creation of the horizontal cutting path 3 based on each prescribed location of a cutting blade of a cutting tool, on an interior wall section 21 in the region 2 on a lower side forming the interior space, at each location in order toward the upper side from a location of the bottom edge or a location of a position apparently near to the bottom edge of the interior wall section 21, with the cutting width of the cutting blade as an unit.

(3) When the location of the horizontal cutting path 3 created in order in step (2) above has reached the location of a final stage, which is the location of the opening top edge 23 or a location below the location 23 of the top edge by a shorter distance than the cutting width, setting of a command for further lamination at the location 23 of the top edge.

(4) A command for joining the bottom edge 11 of the undercut region 1 and the top edge 23 of the interior space-forming region 2.

2. Lamination and sintering in the lower region based on step 1(1) above.
3. Cutting the interior wall section 21 along the horizontal cutting paths 3 created by steps 1(2) and 1(3) above.
4. Lamination and sintering in the undercut region 1 based on steps 1(1) and 1(4) above.

In step 1(3) above, since the command for lamination at the opening of the top edge 23 is set, the step of cutting the opening in the horizontal direction, corresponding to be meaningless and a hindrance to working efficiency is not carried out.

Additionally, since lamination and sintering steps in the top undercut region 1 are actually carried out according to the command as the subsequent stage after cutting for the side section of the opening of the top edge 23, then setting of the command does not constitute any particular hindrance in terms of efficiency of shaping.

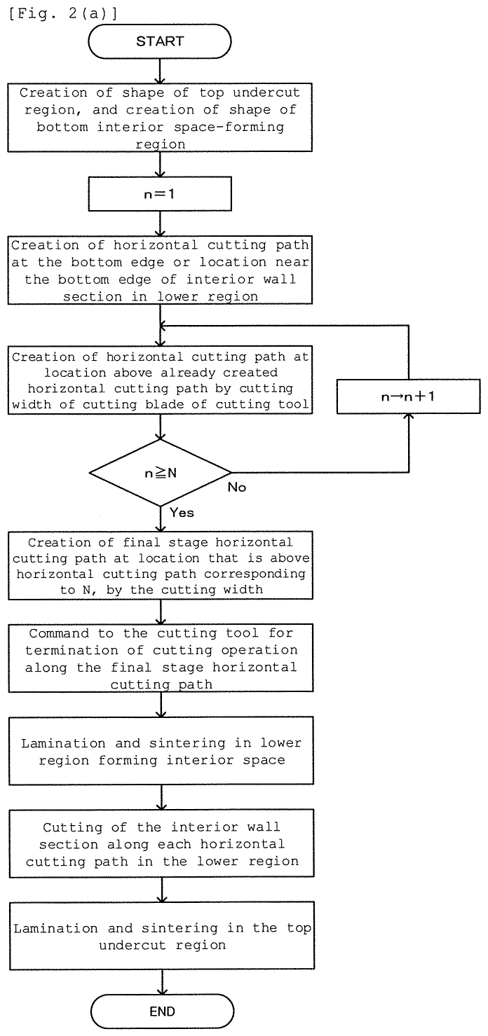

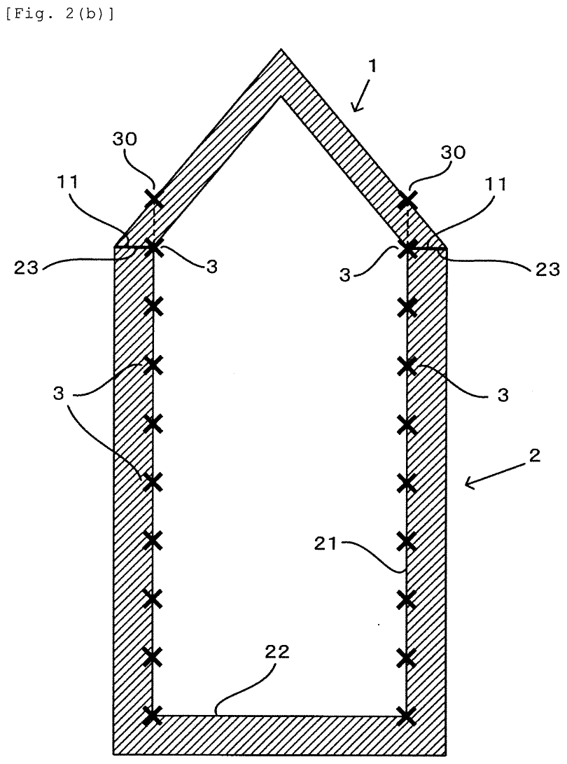

As shown by FIGS. 2(a) and (b), in the basic construction (b), shaping is carried out in the bottom interior space-forming region 2 and then the shaping is carried out in the top undercut region 1, by the following steps.

Note that N in FIG. 2(a) represents the number of the horizontal cutting paths 3 necessary until the horizontal cutting path 3 reaches the location 23 of the top edge in the interior space-forming region 2, or a location below the location by a shorter distance than the cutting width, which is a location that is below the cutting location of the final stage by the cutting width, while FIG. 2(b) represents a case in which the location of the horizontal cutting path 3 corresponding to N of FIG. 2(a) is the location 23 of the top edge.

1. The CAD/CAM system sets the following steps.

(1) Creation of the shape of the top undercut region 1 that has the bottom edge 11 opening, and creation of the shape of the bottom interior space-forming region 2 that has the top edge 23 opening.

(2) Creation of the horizontal cutting path 3 based on each prescribed location of the cutting blade of the cutting tool, on the interior wall section 21 in the region 2 on the lower side forming the interior space, at each location in order toward the upper side from the location of the bottom edge or a location of a position apparently near to the bottom edge of the interior wall section 21, with the cutting width of the cutting blade as the unit.

(3) When the location of the horizontal cutting path 3 created in order by step (2) above has reached the location 23 of the opening top edge or a location below the location 23 of the top edge by a shorter distance than the cutting width, creating the horizontal cutting path 30 as a final stage at the upper side by the cutting width for either above location, and setting of a command for terminating cutting operation at the horizontal cutting path 30 of the final stage for the cutting tool.

(4) A command for joining the bottom edge 11 of the undercut region 1 and the top edge 23 of the interior space-forming region 2.

2. Lamination and sintering in the lower region based on step 1(1) above.
3. Cutting the interior wall section 21 along the horizontal cutting paths 3 created by steps 1(2) and 1(3) above.
4. Lamination and sintering in the undercut region 1 based on steps 1(1) and 1(4) above.

In step 1(3) above, it is possible to carry out cutting for the opening of the top edge 23 in the horizontal direction, since the cutting does not constitute cutting at the final stage by setting the command for terminating cutting along the horizontal cutting path 30 at the final stage which is positioned at upper side of the uppermost cutting path of the basic construction (a) by the cutting width, and corresponds to the uppermost location, and so cutting is carried out along the horizontal cutting path 3 at a second location from the upper side.

Furthermore, since the terminating command is carried out immediately as the subsequent step after completing cutting at the second location from the upper side, the terminating command does not constitute a hindrance against efficient shaping.

Although the uppermost horizontal cutting path 3 stands on idle rolling of the cutting tool, in step 1(3), idle rolling is not carried out actually by the terminating command.

For “each prescribed location of the cutting blade of the cutting tool” in each respective step 1(2) of the basic constructions (a) and (b), it is possible to select any location from the top edge to the bottom edge of the cutting blade, but usually a central location or the bottom edge location will be selected.

So, when the center location of the cutting blade is the reference for the start location of the horizontal cutting path 3 in each respective step 1(2) of the basic constructions (a) and (b), the “location of the bottom edge of the interior wall section 21” must necessarily be selected.

On the other hand, when the location of the bottom edge of the cutting blade is the reference, it is possible to select the “location of the bottom edge or a location near the bottom edge of the interior wall section 21.”

In the basic constructions (a) and (b), it is not always necessary to carry out cutting of the lower side that forms the interior wall section 21 in the undercut region 1.

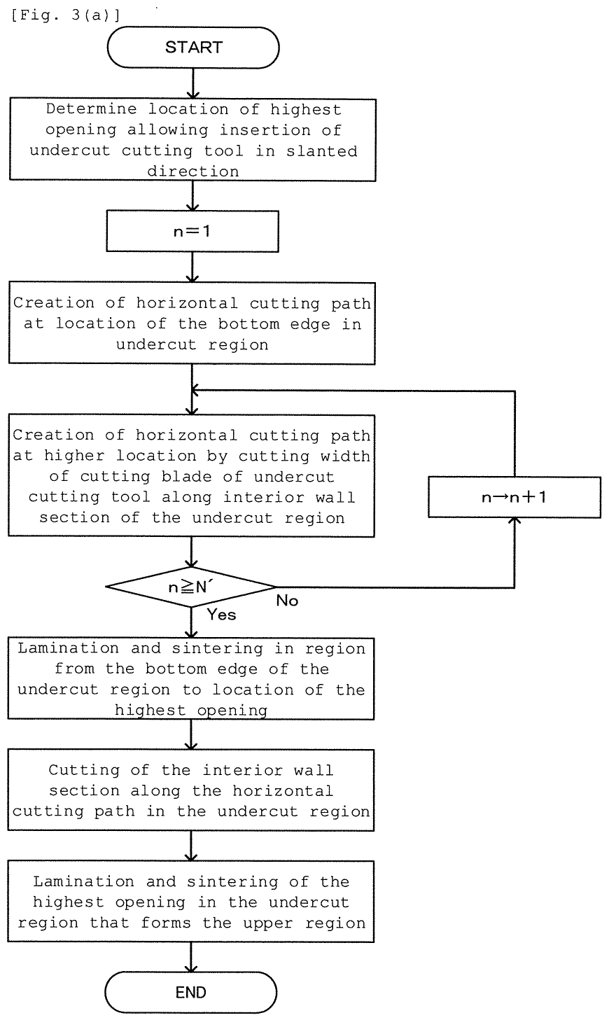

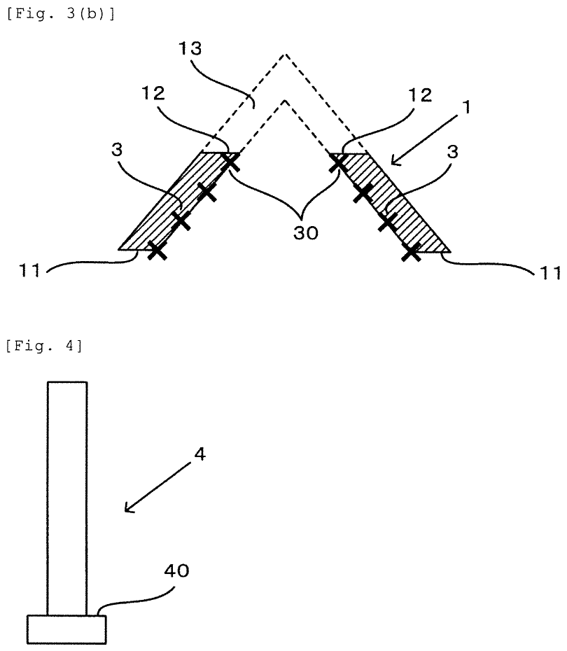

However, for the embodiment consisting of the following steps, as in FIGS. 3(a) and (b), it is possible to carry out cutting of the lower side in the undercut region 1.

Note that N′ in FIG. 3(a) represents the number until the horizontal cutting path 3 created from the bottom edge 11 in the undercut region 1 reaches the horizontal cutting path 30 at the final stage at the location of a highest opening 12 or a location below the location of the highest opening 12 by a shorter distance than cutting width of an undercut cutting tool, as in 1(3) below, while FIG. 3(b) represents a case where the horizontal cutting path 3 corresponding to N′ of FIG. 3(a) is the location below the highest opening 12 by a distance shorter than the cutting direction width.

1. The following steps are set by the CAD/CAM system.

(1) Setting of the location of the highest opening 12 corresponding to the uppermost location that allows inserting an undercut cutting tool in a slanted direction, among openings formed in order on the upper side by lamination and sintering.

(2) Creation of the horizontal cutting path 3 on the interior wall section 21 of the undercut region 1, based on a prescribed location of the cutting blade of the undercut cutting tool, at each location along a slanted direction based on successive undercut angles, from the location 11 at the bottom edge of the undercut region 1, with an unit of the cutting width of the cutting blade.

(3) Continuous creation of the horizontal cutting path 3 in step (2) above, until the location of the horizontal cutting path 3 successively formed by step (1) above reaches the location at the final stage which is the location of the highest opening 12 set by step (2) above or a location below the location of the highest opening 12 by a shorter distance than the cutting width of the undercut cutting tool.

2. Lamination and sintering in the region from the bottom edge 11 of the undercut region 1 to the highest opening 12.
3. Cutting of the interior wall section 21 in the undercut region 1 along the horizontal cutting paths 3 created by steps 1(2) and (3) above.
4. Lamination and sintering of the highest opening 12 in the undercut region 1 that forms an upper region 13.

In this embodiment, when cutting has been carried out by the undercut cutting tool along the horizontal cutting path 3 where the side is the highest opening 12, since the cutting corresponds to cutting at the final stage, the CAD/CAM system must issue a command for cutting of the horizontal plane of the highest opening 12 and the cutting must actually be carried out.

However, when the opening region at the top edge 23 is extremely narrow, there is no major hindrance to the working efficiency even if cutting of the top edge surface 23 has been carried out.

Nevertheless, when the CAD/CAM system has set the command for further lamination at the location of the highest opening 12, and when the horizontal cutting path 30 at the final stage of step 1(3) above has been created, it is possible to avoid cutting of the highest opening 12 in the horizontal direction similar to the case of the basic construction (a).

The invention will now be explained by an example.

### EXAMPLE

For the Example, as shown in FIG. 4, at the stage where lamination and sintering of a bottom section 22 of the three-dimensional shaped product have been completed, a bottom face of the upper side of the bottom section 22 is cut by rotation of the cutting tool which is equipped with a cutting disc 40 at its bottom edge.

For this embodiment, it is possible to efficiently cut the bottom face in the interior space-forming region 2 by a flat rotation disc at the bottom edge of the cutting tool.

### INDUSTRIAL APPLICABILITY

According to the present invention, for shaping of the three-dimensional shaped product constituting the top undercut region and the bottom interior space-forming region, it is possible to avoid cutting of the top edge surface in the interior space-forming region and to accomplish efficient cutting of the interior wall section, and therefore the invention has very high practical value.

### REFERENCE SIGNS LIST

1 Undercut region
11 Bottom edge location and bottom edge surface in undercut region
12 Highest opening in undercut region
13 Upper region at highest opening in undercut region
2 Interior space-forming region
21 Interior wall section
22 Bottom section
23 Top edge location and top edge surface in interior space-forming region
3 Horizontal cutting path
30 Horizontal cutting path at final stage
4 Cutting tool
40 Cutting disc

1. A method for producing a three-dimensional shaped product based on lamination with a powder while a squeegee is traveling, sintering of the laminated layer by irradiation with a laser beam or an electron beam, and cutting of the sintered layer with a traveling cutting tool, the three-dimensional shaped product including a top undercut region and a bottom interior space-forming region which are joined, the method comprising the following steps:
1. performing the following steps which are set by a CAD/CAM system:
(1) creating a shape of the top undercut region that has a bottom edge opening, and creating a shape of the bottom interior space-forming region that has a top edge opening,
(2) creating a cutting path with a horizontal running direction and with a standard on each prescribed location of a cutting blade of the cutting tool, on an interior wall section in a region on a lower side forming the interior space of the bottom interior space-forming region, at each location in order toward an upper side thereof from one of:
a location of a bottom edge of the interior wall section or
a location of a position near to the bottom edge of the interior wall section,
with a cutting width of the cutting blade as a unit,
(3) when the location of the cutting path with the horizontal running direction created in order in step (2) above has reached the location of a final stage, which is one of:
a location of the opening top edge or
a location below the location of the top edge by a shorter distance than the cutting width,
setting a command for further lamination at the location of the top edge, and
(4) issuing a command for joining the bottom edge of the undercut region and the top edge of the interior space-forming region, and
2. laminating and sintering in a lower interior space-forming region based on step 1(1) above,
3. cutting the interior wall section along the cutting paths with the horizontal running direction created by steps 1(2) and 1(3) above, and
4. laminating and sintering in the undercut region based on steps 1(1) and 1(4) above.

2. A method for producing a three-dimensional shaped product based on lamination with a powder while a squeegee is traveling, sintering of the laminated layer by irradiation with a laser beam or an electron beam, and cutting of the sintered layer with a traveling cutting tool, the three-dimensional shaped product including a top undercut region and a bottom interior space-forming region which are joined, the method comprising the following steps:
1. performing the following steps which are set by a CAD/CAM system:
(1) creating a shape of the top undercut region that has a bottom edge opening, and creating a shape of the bottom interior space-forming region that has a top edge opening,
(2) creating a cutting path with a horizontal running direction and with a standard on each prescribed location of a cutting blade of the cutting tool, on an interior wall section in a region on a lower side forming the interior space of the bottom interior space-forming region, at each location in order toward an upper side thereof from one of:
a location of a bottom edge of the interior wall section or
a location of a position near to the bottom edge of the interior wall section,
with a cutting width of the cutting blade as a unit,
(3) when the location of the cutting path with the horizontal running direction created in order by step (2) above has reached the location of an opening top edge of a location below the location of the top edge by a shorter distance than the cutting width, creating a cutting path with the horizontal running direction as a final stage at an upper side by the cutting width for either above location, and setting of a command for terminating a cutting operation at the cutting path with the horizontal running direction of the final stage for the cutting tool,
(4) issuing a command for joining the bottom edge of the undercut region and the top edge of the interior space-forming region, and
2. laminating and sintering in a lower interior space-forming region based on step 1(1) above,
3. cutting the interior wall section along the horizontal cutting paths with the horizontal running direction created by steps 1(2) and 1(3) above, and
4. laminating and sintering in the undercut region based on steps 1(1) and 1(4) above.

3. A method for producing a three-dimensional shaped product by joining between the undercut region having a fixed undercut angle on the upper side of the bottom interior space-forming region according to claim 1, wherein lamination, sintering and cutting are carried out in the undercut region by the following steps:
1. performing the following steps which are set by a CAD/CAM system:
(1) setting a location of a highest opening corresponding to an uppermost location that allows inserting an undercut cutting tool to be inserted in a slanted direction, among openings formed in order on an upper side by lamination and sintering,
(2) creating a cutting path with a horizontal running direction on an interior wall section of the undercut region, and with a standard on a prescribed location of a cutting blade of the undercut cutting tool, at each location along a slanted direction based on successive undercut angles, from a location at the bottom edge of the undercut region, with a unit of the cutting width of the cutting blade,
(3) continuously creating the cutting path with the horizontal running direction in step (2) above, until the location of the cutting path with the horizontal running direction successively formed by step (1) above reaches a location at a final stage which is one of:
a location of a highest opening set by step (2) above or
a location below the location of the highest opening by a shorter distance than the cutting width of the undercut cutting tool,
2. laminating and sintering in the region from the bottom edge of the undercut region to the highest opening,
3. cutting of the interior wall section in the undercut region along the cutting paths with the horizontal running direction created by steps 1(2) and 1(3) above, and
4. laminating and sintering of the highest opening in the undercut region that forms the upper region.

4. A method for producing a three-dimensional shaped product by joining between the top undercut region and the bottom interior space-forming region according to claim 3, further comprising the step of having the CAD/CAM system set a command for further lamination at the location of the highest opening, when creation of the cutting path with the horizontal running direction of step 1(3) above has been reached.

5. A method for producing a three-dimensional shaped product by joining between the top undercut region and the bottom interior space-forming region according to claim 1, wherein, at the stage where lamination and sintering of a bottom section in the lower side region have been completed, cutting a bottom face of the upper side of the bottom section by rotation of the cutting tool equipped with a cutting disc at a bottom edge thereof.

6. A method for producing a three-dimensional shaped product by joining between the undercut region having a fixed undercut angle on the upper side of the bottom interior space-forming region according to claim 2, wherein lamination, sintering and cutting are carried out in the undercut region by the following steps:
1. performing the following steps which are set by a CAD/CAM system:
(1) setting a location of a highest opening corresponding to an uppermost location that allows inserting an undercut cutting tool to be inserted in a slanted direction, among openings formed in order on an upper side by lamination and sintering,
(2) creating a cutting path with a horizontal running direction on an interior wall section of the undercut region, and with a standard on a prescribed location of a cutting blade of the undercut cutting tool, at each location along a slanted direction based on successive undercut angles, from a location at the bottom edge of the undercut region, with a unit of the cutting width of the cutting blade,
(3) continuously creating the cutting path with the horizontal running direction in step (2) above, until the location of the cutting path with the horizontal running direction successively formed by step (1) above reaches a location at a final stage which is one of:
a location of a highest opening set by step (2) above or
a location below the location of the highest opening by a shorter distance than the cutting width of the undercut cutting tool,
2. laminating and sintering in the region from the bottom edge of the undercut region to the highest opening,
3. cutting of the interior wall section in the undercut region along the cutting paths with the horizontal running direction created by steps 1(2) and 1(3) above, and
4. laminating and sintering of the highest opening in the undercut region that forms the upper region.

7. A method for producing a three-dimensional shaped product by joining between the top undercut region and the bottom interior space-forming region according to claim 6, further comprising the step of having the CAD/CAM system set a command for further lamination at the location of the highest opening, when creation of the cutting path with the horizontal running direction of step 1(3) above has been reached.

8. A method for producing a three-dimensional shaped product by joining between the top undercut region and the bottom interior space-forming region according to claim 2, wherein, at the stage where lamination and sintering of a bottom section in the lower side region have been completed, cutting a bottom face of the upper side of the bottom section by rotation of the cutting tool equipped with a cutting disc at a bottom edge thereof.
